(19) United States
(12) Patent Application Publication
(10) Pub. No.: US 2026/0004101 A1
(43) Pub. Date: Jan. 1, 2026

(54) CENTRALIZED DISTRIBUTED AGENTIC AI

(71) Applicant: DUO ZHANG, Calabasas, CA (US)

(72) Inventor: DUO ZHANG, Calabasas, CA (US)

(21) Appl. No.: 19/182,270

(22) Filed: Apr. 17, 2025

Related U.S. Application Data
(60) Provisional application No. 63/638,852, filed on Apr. 25, 2024.

(51) Int. Cl. G06N 3/004; G06N 3/092; G06N 5/022

(52) U.S. Cl. CPC G06N 3/004; G06N 3/092; G06N 5/022

(57) ABSTRACT

A centralized distributed agentic artificial intelligence system has a central brain agent. The central brain agent is configured to act as a coordinator agent. The coordinator agent receives input from an operator. The coordinator agent has a coordinator agent large language model that updates knowledge to a knowledge graph. The coordinator agent receives historical data from the knowledge graph to a reinforcement learning policy optimization. The reinforcement learning policy optimization sends model optimizing policy to the coordinator agent large language model. Tentacle agents are configured to act as interface agents. The interface agents have a third-party system integration interface to a third-party system. The plurality of tentacle agents each have an interface agent large language model, local decision making model, and a goal setting and task delegation model. The interface agent large language model receives feedback from an interface agent reinforcement learning policy optimization.

The present invention is a continuation in part of and claims priority from United States provisional application by Duo Zhang 63/638,852 filed Apr. 25, 2024 entitled A Multi-Agent AI System Methodology For Global Trade Industry, the disclosure of which is incorporated herein by reference.

### FIELD OF THE INVENTION

The present invention is in the field of centralized distributed agentic artificial intelligence.

### DISCUSSION OF RELATED ART

A variety of distributed AI management systems have been discussed in United States patents for such items as enterprise management platforms, logistics systems, and distributed additive manufacturing. For example, in United States publication number 2021/0133670 entitled, “Control Tower and Enterprise Management Platform with a Machine Learning/Artificial Intelligence Managing Sensor and The Camera Feeds into Digital Twin,” by Charles Howard, Richard Spitz, and Taymour S. El-Tahry, published May 6, 2021, the inventors describe, “An information technology generally including a set of monitoring facilities that are configured to monitor the value chain network entities; a set of applications that are configured to direct an enterprise to manage the value chain network entities of the platform from a point of origin to a point of customer use; and a machine learning/artificial intelligence system configured to generate recommendation for placing at least one of an additional sensor and a camera on and/or in proximity to a value chain network entity of the value chain network entities, and wherein data from the at one least one of the additional sensor and the camera feeds into a digital twin that represents the value chain network entities.”

For example, in United States publication number 2021/0357850 entitled, “Control Tower and Enterprise Management Platform with Trainable Expert Agents for Value Chain Networks,” by Charles Howard, Richard Spitz, Andrew Cardno, Jenna Parenti, Brent Bliven, and Joshua Dobrowitsky, published Nov. 18, 2021, the inventors describe, “A value chain system that provides recommendations for designing a logistics system generally includes a machine learning system that trains machine-learned models that output logistics design recommendations based on training data sets that each respectively defines one or more features of a respective logistic system and an outcome relating to the respective logistics system; an artificial intelligence system that receives a request for a logistics system design recommendation and determines the logistics system design recommendation based on one or more of the machine learned models and the request; and a digital twin system that generates an environment digital twin of a logistics environment that incorporates the logistics system design recommendation, and one or more physical asset digital twins of physical assets. The digital twin system executes a simulation based on the logistics environment digital twin, the one or more physical asset digital twins.”

For example, in United States publication number 2022/0058569 entitled, “Artificial Intelligence System for Control Tower and Enterprise Management Platform Managing Logistics System,” by Charles Howard, Richard Spitz, Teymour S. El-Tahry, Andrew Cardno, Jenna Parenti, Brent Bliven, and Joshua Dobrowitsky, published Feb. 24, 2022, the inventors describe, “A value chain system that provides recommendations for designing a logistics system generally includes a machine learning system that trains machine learned models that output logistics design recommendations based on training data sets that each respectively defines one or more features of a respective logistic system and an outcome relating to the respective logistics system; an artificial intelligence system that receives a request for a logistics system design recommendation and determines the logistics system design recommendation based on one or more of the machine learned models and the request; and a digital twin system that generates an environment digital twin of a logistics environment that incorporates the logistics system design recommendation, and one or more physical asset digital twins of physical assets. The digital twin system executes a simulation based on the logistics environment digital twin, the one or more physical asset digital twins.”

For example, in United States publication number 2023/0236552 entitled, “Digital-Twin-Enabled Artificial Intelligence System for Distributed Additive Manufacturing,” by Charles Howard Cella, Brent Bliven, and Kunal Sharma, published Jul. 27, 2023, the inventors describe, “An information technology system for a distributed manufacturing network includes an additive manufacturing platform configured to manage workflows for a set of distributed manufacturing network entities associated with the distributed manufacturing network. The information technology system includes a set of digital twins generated by the additive manufacturing platform. The information technology system includes an artificial intelligence system configured to be executed by a data processing system in communication with the additive manufacturing platform. The artificial intelligence system is trained to generate process parameters for the workflows managed by the additive manufacturing platform using data collected from the set of distributed manufacturing network entities. The information technology system includes a control system configured to adjust the process parameters during an additive manufacturing process performed by at least one of the set of distributed manufacturing network entities.”

For example, in United States publication number 2023/0341850 entitled, “Robot Fleet Management Configured for Use of an Artificial Intelligence Chipset,” by Charles Howard Cella, Teymour S. El-Tahry, and Leon Fortin Jr., published Oct. 26, 2023, the inventors describe, “A method of configuring a robot of a fleet of robots for use of an AI chipset includes receiving a request for a robotic fleet to perform a job. The method includes defining a set of tasks that are to be performed by the robotic fleet in performance of the job. The method includes assigning at least one task of the set of tasks to a robot. The method includes determining a configuration for the robot based on the assigned task and a components inventory that indicates different components that can be provisioned to the robot including at least one AI chipset, and for each component, a set of extended capabilities and a status of the component. The method includes configuring the robot based on the determined configuration to use the at least one AI chipset. The method includes deploying the robotic fleet to perform the job.”

### SUMMARY OF INVENTION

A centralized distributed agentic artificial intelligence system has a central brain agent. The central brain agent is configured to act as a coordinator agent. The coordinator agent receives input from an operator. The coordinator agent has a coordinator agent large language model that updates knowledge to a knowledge graph. The coordinator agent receives historical data from the knowledge graph to a reinforcement learning policy optimization. The reinforcement learning policy optimization sends model optimizing policy to the coordinator agent large language model.

Tentacle agents are configured to act as interface agents. The interface agents have a third-party system integration interface to a third-party system. The plurality of tentacle agents each have an interface agent large language model, local decision making model, and a goal setting and task delegation model. The interface agent large language model receives feedback from an interface agent reinforcement learning policy optimization. The interface agent reinforcement learning policy optimization receives input from an agent response.

A nervous system includes a message broker and the central brain agent publishes and subscribes to the message broker. The plurality of tentacle agents publish and subscribe to the message broker. The coordinator agent and interface agents communicate through the message broker. The central brain has a large language model and reinforcement learning policy optimization. The reinforcement learning policy optimization improves the policy of the large language model. The plurality of tentacle agents have a large language model and reinforcement learning policy optimization. The reinforcement learning policy optimization improves the policy of the large language model.

The coordinator agent has a coordinator agent large language model which sends a query response and aggregate data. The coordinator agent large language model receives responses from the decision-making model. The decision making model sends strategic directives to the goal setting task delegation model, and receives task outcome data from the goal setting task delegation model. The interface agent's large language model gives an interface agent response to the operator. The operator gives human feedback to the interface agent's reinforcement learning policy optimization model. The interface agent's reinforcement learning policy optimization model also receives an agent response from other tentacle agents and receives central brain feedback.

The centralized distributed agentic artificial intelligence system is configured for international trade. The interface agents include: a sales agent; a workflow agent; and a marketplace agent.

The present invention centralized distributed artificial intelligence system has wide applications such as for customs brokerage. When applied to the customs brokerage, a wide variety of different manual tasks such as data entry, manual scans of regulations, handling e-mails, communications between clients and customs officials can be automated. This would decrease the cost of labor in a customs brokerage by 30 to 50%. The customer's information is stored so that there is no need for repetitive tasks as everything can be done with agentic AI memories and records.

The large language model is multilingual, and this allows vendors to reach international markets without language difference barriers and dealing with unfamiliarity with foreign regulations and trade practices. Also, shipping goods across borders often involves navigating complex logistics, customs procedures and transportation regulations. These complex logistics can be handled using the centralized distributed agentic artificial intelligence system. Due to high costs, managing global trade often comes with significant costs related to customs duties, tariffs, shipping fees and compliance with international standards. Lenders may find it challenging to optimize costs and maintain competitive pricing. Because of this, the present invention can assist with minimizing costs of operation. The lack of transparency in trade can make it difficult for vendors to find reliable information about potential markets buyers or suppliers, leading to uncertainties, missed opportunities and errors.

For example, a tentacle agent can be optimized as a sales agent and the sales agent can perform different functions such as customer on boarding by gathering client information and import export requirements. The sales agent can also create customer profiles with relevant details such as contact information and shipping preferences. The sales agent can also perform the function of quoting and pricing. The sales agent can provide automated quoting based on shipment sizes such as size, weight, dissemination. The sales agent can also calculate customs duties taxes and other fees as well as provide pricing options based on different service levels. The sales agent can also automate e-mails and e-mail responses. The sales agent can also integrate with existing customer relationship management systems to assist with managing customer interactions and relationships and keeping track of client preferences history of feedback.

Another example is a workflow agent where a tentacle agent can be optimized as a workflow agent. The workflow agent can perform functions such as automatic data entry by extracting data from shipping documents using OCR technology and maintaining the records such as invoices, packing lists, bills of lading. The workflow agent can also populate entry forms with extracted data to minimize manual data entry. The workflow agent can also use machine learning algorithms to classify products according to the harmonized system codes based on descriptions of classification and tariff. The workflow agent can provide recommendations on applicable tariffs and duties based on product classification. The workflow agent can also perform regulatory compliance checks against customs regulations and policies to ensure entries meet all requirements. The workflow agent can also flag potential compliance issues or errors before submission. The workflow agent can also prepare documents and submit them by generating and compiling necessary customs documents automatically including entry summaries and declarations. The workflow agent can also submit these entry filings electronically to customs authorities integrating with relevant custom systems. The workflow agent can also detect and correct errors, and in data entry and provide suggestions for corrections to ensure data accuracy and compliance.

A tentacle agent can also be optimized as a marketplace agent and perform functions such as vendor matching and recommendations. For example, vendor matching and recommendations can include the step of utilizing machine learning algorithms to match buyers with suitable vendors based on their specific requirements preferences and historical transactions. Additionally, a tentacle agent can perform a product search and discovery including enhancing product search capabilities using natural language processing to understand user queries and return relevant results. The tentacle agent can also optimize and negotiate prices such as by implementing dynamic pricing algorithms that are just based on market demand to supply and other factors or support automated negotiation processes between buyers and vendors. The tentacle agent can also optimize supply chains by using artificial intelligence to optimize supply chain management such as inventory forecasting, demand prediction and logistics planning. This has the goal of reducing inefficiencies and costs in the supply chain through data-driven insights. Additionally, the marketplace agent can perform transaction security and fraud prevention such as implementing AI powered fraud detection systems to identify and prevent fraudulent transactions. This also enhances security measures for financial transactions within the marketplace.

The centralized distributed agentic artificial intelligence system present invention can also facilitate a marketplace. The marketplace can minimize the downside of lack of transparency. The present invention facilitates market access such that a marketplace provides vendors with access to a broader consumer base both domestically and internationally by consolidating buyers and sellers onto a single platform. The AI solution also optimizes logistics with an integrated logistics solutions including shipping and customs clearance services to simplify the process of fulfilling international orders.

The present invention also leverages economies of scale such that the marketplace can negotiate better rates with logistics providers and streamline payment processing, reducing costs for vendors. The present invention also mitigates risk so that marketplace platforms can provide secure payment systems and escrow services reducing the risk of fraud and payment disputes in cross-border transactions. The present invention also allows the operation of an aggregator marketplace. The present invention can also be optimized to provide compliance support so that marketplaces can assist vendors in navigating regulatory complexities by providing guidance on customs procedures, legal requirements and compliance standards across different markets.

When all the tentacle agents work together under a central brain agent, the present invention can perform multiple tasks simultaneously including risk assessment, tariff classification, screening transactions, documentation, and monitoring. The present invention can assess transaction risk using origin destination product and regulations data reducing noncompliance risk. The present invention can then classify goods to avoid misclassification and penalties in global trade. The resin invention can then screen transaction parties against watch lists to avoid prohibited or restricted business interactions. The present invention can then automate document creation ensuring accuracy and compliance with regulations. The present invention can then monitor transactions for anomalies and prevent fraud and noncompliance risks in real-time.

### BRIEF DESCRIPTION OF THE DRAWINGS

FIG. 1 is a general diagram showing use of AI agent for an agent business customs broker.

FIG. 2 is a general diagram describing three components of a multi-agent AI system.

FIG. 3 is a product architecture logic mapping.

FIG. 4 is a diagram showing the coordinator agent in relation to the centralized distributed agentic AI system.

FIG. 5 is a diagram showing integration of the interface agent AI brain to the centralized distributed agentic AI system.

FIG. 6 is a diagram of the physical implementation of the AI system.

FIG. 7 is a diagram showing third-party integration interface in tentacle agents.

FIG. 8 is a diagram showing interaction between the nervous system and various tentacle agents.

FIG. 9 is a diagram showing subscribed messages, published messages and feedback communication between the tentacle agent and central brain through the nervous system.

FIG. 10 is a diagram showing the tentacle agents as part of an entire multiagent AI system.

FIG. 11 is a diagram showing a use case of the present invention.

The following call out list of elements can be a useful guide in referencing the element numbers of the drawings.
101 AI Agent for an Agent business-Custom Broker
102 AI Agent Software
103 Custom Brokerage
104 Save Cost, Increase Efficiency, Scale up
201 3 Components multi-Agent AI System
202 Customer/Clients
203 Sales Agent
204 Custom Broker
205 Workflow Agent
206 Marketplace/Vendor Aggregate Agent
207 Agent Components (including 1. Sales Agent, 2. In House Workflow Agent, 3. Marketplace/Vendor Aggregate Agent)
300 Centralized distributed agentic AI System
301 Pre-training
302 Fine-Tuning
303 Collect Demo Data and Train Supervised Strategy
304 Comparing Data and Train Reward Modeling (RM)
305 Optimize Strategy with Using PPO Reinforcement Learning (RL or RM)
306 Neutral Network and Deep Learning
307 Large Language Model (LLM)
308 Generative AI
309 Generative Pre-training Transformer (GPT)
310 Ai Questioning-answering Model
311 Various Regulatory Documents
312 User Manual
313 Supplier Agreement
314 AI Automatic Generation
315 Generated Fake Samples with Using Latent Space and Noise
316 Fine Tune Training
317 Improve the Model Accuracy and Efficiency of Data Analysis and Evaluation
318 Standard Normal Distribution Generates Trading Data as Input to the Decoder
319 Generate New Trading Samples
320 Generative Adversarial Network (GAN)
348 Documentation
321 Variational Autoencoder (VAE)
322 Duties
323 Machine Learning Classifier
324 Harmonized System with AI
325 Classification
326 Data Evaluation and Prediction
327 Market Trend Analysis and Risk Prediction
328 Select the Right Business Decision
329 Convolutional Neural Network (CNN)
330 Recurrent Neural Network
331 Long Short-term Memory (LSTM)
332 Data Evaluation and Prediction
333 Market Trend Analysis and Risk Prediction
334 Select the Right Business Decision
335 Convolutional Neural Network (CNN)
336 Recurrent Neural Network (RRN)
337 Long Short-term Memory (LSTM)
338 Data Security and Privacy
339 Protect the User Data Encryption
340 Homomorphic Encryption
341 Differential Privacy
342 Date Transparency and Security
343 Blockchain
344 Filtering
345 Filter Suppliers with AI
346 Filter Customers with AI
347 Filter Intermediaries with AI
401 Knowledge Graph
402 Query Data as LLM Context
403 Multimodal Human Input
400 Central AI Brain (Coordinator Agent)
404 Operator
405 Response
406 Update Knowledge
407 Large Language Model
408 Query Response & Aggregates Data
409 Response
410 Human Feedback
411 Improves Model by Optimizing Policy
412 Global Decision Making
413 Use Historical Data
414 Strategic Directives
415 Outcome of Task
416 Goal Setting/Task Delegation
417 Reinforcement Learning Policy Optimization
418 Delegated Tasks
419 Agent Response
420 Tentacle Agents (Through Nervous System)
421 Adapting and Learning
422 Outside Environment
500 Central AI Brain Feedback
501 Third-Pary System
502 Interface
503 Third-Party System Integration Interface
504 Central AI Brain (Through Nervous System)
505 Multimodal Human Input
525 Operator
524 Response
506 Task Input
507 Distributed Tentacle Agents (Interface Agents)
524 Response
508 Large Language Model
509 Query Response & Aggregates Data
523 Response
510 Human Feedback
511 Strategic Directives
512 Decision Making
513 Improves Model by Optimizing Policy
514 Stream Data
515 IoT Devices
516 Goal Setting/Task Delegation
517 Outcome of Task
518 Reinforcement Learning Policy Optimization
519 Other Tentacle Agents (Through Nervous System)
520 Agent Response
521 Adapting and Learning
522 Outside Environment
523 Delegated Tasks
530 Query Response & Aggregates Data
600 Nervous System
601 Knowledge Graph
602 IoT Devices
603 Query Data
604 Publishes Data
605 Update
606 API Gateway
607 Message Broker (RabbitMQ, Kafka)
608 Topics
609 Subscribes/Publishes
610 Display
611 User Interface
612 Agents (Central Brain/Tentacle Agent)
700 Third Party System
701 Custom Connector
702 Tool 1
703 Tool 2
704 Tool 3
705 Tool Use
706 Devices Service Needed
707 Request & Response
708 Third-Part Integration Interface
709 Distributed Tentacle Agents (Interface Agents)
712 Central AI Brain (Through Nervous System)
713 Operator
710 Large Language Model
711 Decision Making
801 Tentacle Agent
802 Large Language Model
803 Improves Policy Published Message
804 Reinforcement Learning Policy Optimization
805 Feedback
806 Improves Policy
807 Published Message
800 Nervous System
811 Message Broker (RabbitMQ, Kafka)
808 Topics
809 Subscribed Message
810 Feedback
901 Human Feedback
902 Multimodal Human Input
921 Operator
903 Response
904 Central brain
905 Large Language Model
906 Improves Policy
907 Reinforcement Learning Policy Optimization
908 Feedback
909 Published Message
910 Context
911 Knowledge Graph
912 Update
913 Nervous System
924 Message Broker (RabbitMQ, Kafka)
914 Topic
915 Subscribed Message
916 Feedback
917 Large Language Model
918 Tentacle Agent
919 Reinforcement Learning Policy Optimization
920 Improves Policy
1000 Central Brain Agent
1001 Tentacle Agent 1
1002 Tentacle Agent 2
1003 Tentacle Agent 3
1004 Tentacle Agent 4
1005 Tentacle Agent 5
1006 Tentacle Agent 6
1007 Tentacle Agent 7
1008 Tentacle Agent 8
1010 Publish/Subscribe
1011 Message Broker
1012 Operator

### DETAILED DESCRIPTION OF THE PREFERRED EMBODIMENT

The following glossary may be useful in defining terms used in this disclosure.

### Glossary

AI: Artificial Intelligence
Agent: In the context of AI, an agent is an entity that perceives its environment acts upon that environment through actuators to achieve specific goals including:
1. Perception: The agent receives input from its environment via sensors or data feeds (e.g., system APIs, user input, IoT devices).
2. Action: Based on the information it perceives, the agent takes actions using its actuators. For a robot, this might mean moving its limbs, while for a software agent, it could mean making decisions or sending data.
3. Goal-Orientation: Agents are designed to achieve specific goals or objectives. They use their perception and actions to navigate towards these goals.
4. Autonomy: Agents operate autonomously, meaning they can make decisions and take actions without human intervention.
5. Types of Agents:
   Simple Reflex Agents: These agents respond directly to percepts from the environment without considering the history of percepts.
   Model-Based Reflex Agents: These agents maintain an internal state to keep track of the part of the world they can't see.
   Goal-Based Agents: These agents act to achieve specific goals, considering future consequences of their actions.
   Utility-Based Agents: These agents aim to maximize their own utility or satisfaction, often balancing multiple goals.
PPO: Proximal Policy Optimization. A type of reinforcement learning algorithm developed to train intelligent agents by optimizing their policies in a way that balances performance and stability. PPO is a policy gradient method, which means it directly optimizes the policy that the agent uses to decide its actions. PPO improves training stability by avoiding large updates to the policy, which can destabilize learning. It does this by clipping the policy update to keep it within a certain range.
RL: reinforcement learning. A type of machine learning Warren agent learns to make decisions by interacting with an environment to maximize some notion of cumulative reward.
RM: a reward model that defines the rewards an agent receives for its actions.
GPT: generative pretraining transformer
LLM: large language model
GAN: generative adversarial network
VAE: variational auto encoder
CNN: convolutional neural network
LSTM: long short-term memory
Gibberlink: a modulated audio language between AI and AI
RabbitMQ: a general-purpose open-source message broker
Kafka: a message broker on a distributed streaming platform for facilitating communication between different parts of a distributed system.

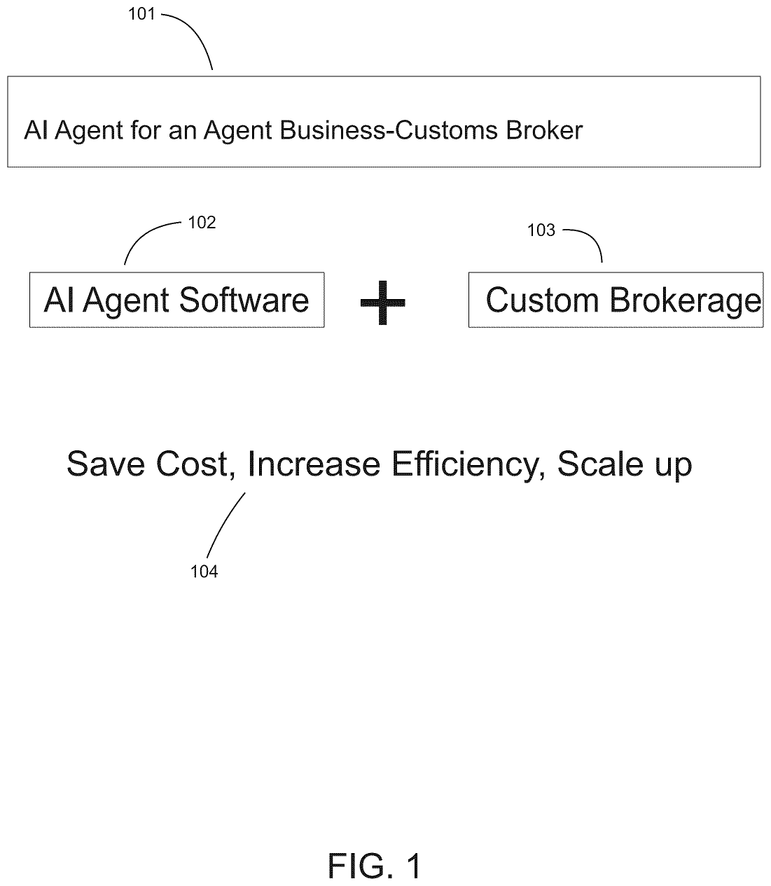

As seen in FIG. 1, an AI Agent for an agent business customs broker 101 can include an AI agent software 102 that interacts with a custom brokerage 103 to produce the result of saving cost, increasing efficiency and scaling up 104.

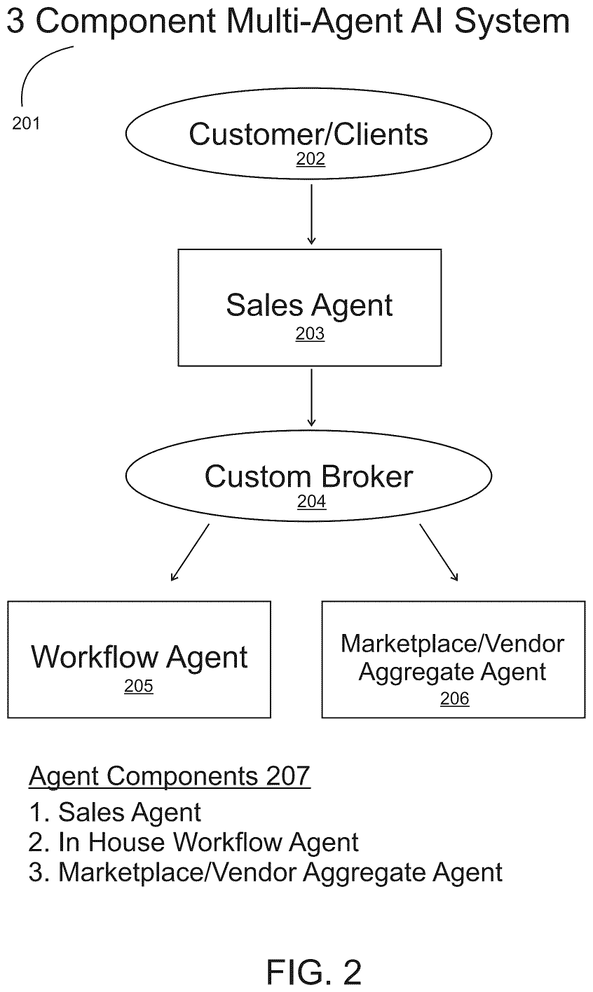

As seen in FIG. 2, a centralized distributed agentic AI may have a three component multiagent AI system 201. Here, the customer and clients 202 interact with a sales agent 203. The sales agent then interacts with the customs broker 204. The customs broker interacts with the workflow agent 205 and the marketplace vendor aggregate agent 206. In this case, the agent components 207 of the centralized distributed agentic AI system include the sales agent, the in house workflow agent, and the marketplace vendor aggregate agent.

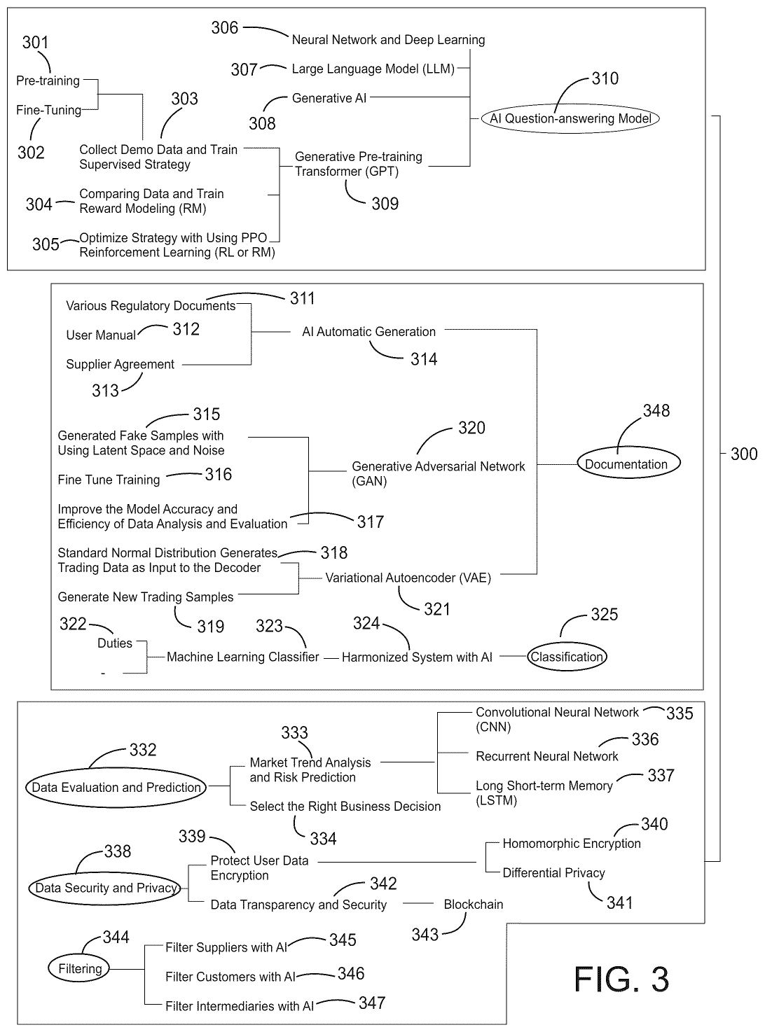

As seen in FIG. 3, the centralized distributed agentic AI system 300 of the present invention is built first with pretraining 301 and fine-tuning 302. The pretraining step 301 and the fine-tuning step 302 then allow for collection of demonstration data and training for a supervised strategy step 303. The collection of demonstration data and training for supervised strategy step 303, is followed by a comparing data and train reward modeling step 304 abbreviated as the RM step. The RM step 304 can further improve the weights of the AI system using a step of optimizing strategy using PPO reinforcement learning 305. The three training steps thus builds a generative pretraining transformer GPT 309 which can operate with a large language model 307, a generative AI 308 and a mural network and deep learning algorithm 306 to create an AI questioning answering model 310.

The three training strategies and components 303, 304, 305 are pre-trained 301 and fine-tuned 302 which are used to train the Generative Pre-training Transformer 309. The Generative Pre-training Transformer 309 is pre-trained with the Demo Data and Supervised strategy 303. The Demo data and trained supervised strategy 303 is created from pre-training 301 and fine-tuning 302. The Generative Pre-training Language Model 309 is formed first through a large unlabeled data set which prepares it to be fine tuned. Pre-training 301 allows for a more general training to narrow the trained models such as collected demo data and trained supervised strategy 303, Comparing Data and Trained Reward Modeling 304, and Optimize Strategy with Using PPO Reinforcement Learning 305. During fine-tuning 302, a more specific and labeled data set is used to train the model which further specializes the model for performance in the desired task logistics, customs, brokerage, etc. As a result of these two processes, collected demo data and trained supervised strategy 303, Comparing Data and Trained Reward Modeling 304, and Optimize Strategy with Using PPO Reinforcement Learning 305 are specialized as components and agents of the Generative Pre-training Transformer 309. An agent in the context of machine learning is an entity which interacts with an environment to learn optimal behavior through trial and error. Thus, the generative pre-training transformer 309 is pre-trained with the demo data and supervised strategy 303. The demo data and trained supervised strategy 303 is created from pre-training 301 and fine-tuning 302. The pretrained model is formed first through a large unlabeled data set which prepares it to be fine-tuned. During fine-tuning 302, a more specific and labeled data set is used to train a more specified model which trains the supervised strategy. As a result of these two processes, collected demo data and trained supervised strategy 303, comparing data and trained reward modeling 304, and optimize strategy with using PPO reinforcement learning 305 are specialized as components of the generative pre-training transformer 309.

The Comparing Data and train Reward Modeling step 304 creates a basis of reference for the Generative Pre-training transformer 309 to help determine human choices and preferences. The compared data in 304 comes from human input and aids in design of the loss function for the reward model. Comparing Data and Train Reward Modeling 304 aids in prediction for quality of the Generative Pre-training Transformer 309 and the AI Question-answering Model's 310 written output. Different from true Reinforcement Learning in 305, Reward Modeling in 304 focuses more on single or few step feedback rather than long term optimization. Reward Modeling 304 also includes human feedback as part of the reinforcement learning system. The Comparing Data part of 304 presents multiple options for a human evaluator to choose from and records the chosen and rejected response. The response data contributes to the loss function found in Reward Models 304 which indicates the closeness to human preference. The Comparing Data and Reward Modeling 304 step helps to get this value as close as possible to alignment with human preferences or a value of 0. Based on the feedback ranking, this would indicate a high reward score for the chosen response and a low reward score for the rejected response. The Optimize Strategy and Use PPO Reinforcement Learning 305 step also contributes to creating the Generative Pre-training Transformer 309. PPO means proximal policy optimization which helps an agent to optimize policies, or strategies for decision making. The policies aid in an agent's interaction with the environment, often represented as a neural network with tunable parameters. The optimization part of PPO 305 adjusts parameters based on reward inputs through interacting with the environment. A key benefit to PPO 305 from this optimization is that the optimization strategy utilizes the surrogate objective function. The surrogate objective function prevents the new policy from deviating too much from the old policy and minimizes risk of large and potentially destabilizing changes which can be catastrophic for model performance.

This training process 305 begins with the agent set in an environment and randomly choosing and begins training towards positive rewards. As a result, the agent eventually maximizes the cumulative reward signal more consistently. The Generative Pre-training Transformer 309 is a neural network model used to convert a set of data using the pretrained models to transform word inputs into word outputs to predict the next word in a sequence of words. The Generative Pre-training Transformer 309 uses a series of linear algebra calculations in the form of linear transformations. Each matrix in a transformer is assigned various scalar value weights that act like fine-tuning knobs. These knobs point to the context and relevance of a word in relation to other words. In the previous steps of the Generative Pre-training Transformer 309 matrices are constantly fine tuned which are later used to transform input vectors. Words are represented in a matrix with thousands of dimensions in the form of vector representations called embeddings. After training through many matrix multiplications, the weighted matrices in the Generative Pre-training Transformer 309 enable the AI Question-answering Model 310 to learn patterns and relationships between words and numbers. The Generative Pre-training Transformer is a type of Neural Network that not only uses Reward Modeling 304, a Supervised Strategy 303, and PPO Reinforcement Learning 305, but also deep learning 306 to build the AI Question-answering Model 310. Deep learning in this case can be used in addition to 303-305 to build the Generative Pre-training Transformer 309 or in combination with the Generative Pre-training Transformer 309 to build the AI Question-answering Model 310. By having multiple methods 303-306 with the order of the parts and relationships to train the AI Question-answering Model 310 through the Generative Pre-training Transformer 309, the model is more robust and has more complex pattern recognition. The multiple methods and strategies also improve accuracy and help the model to better adapt to various situations. The Generative Pre-training Transformer 309 is specifically a Large Language Model 307 which uses the transformer architecture. In this case, the AI is a chatbot that answers questions. The Generative Pre-training Transformer 309 as a Large Language Model 307 is a type of Generative AI which aids in Custom Brokerage 103. The AI Question-answering Model 310 is then used in part to create the AI Agent Software 102.

The centralized distributed agentic AI system 300 also includes a documentation step 348. The documentation step includes the substeps of providing AI automatic generation 314 of documents, creating a generative adversarial network GAN 320, and pretty a variational auto encoder 321. A variety of different documents related to import export logistics such as the step of providing various regulatory documents 311, the step of providing user manuals 312, and the step of providing supplier agreements 313 can train the AI automatic generation 314. The substep of creating generated fake samples with using latent space and noise 315, the subsequent substep of fine tune training 316 and the substep of improving the model accuracy and efficiency of data analysis and evaluation provides the step of creating the generative adversarial network 320.

The step of providing customs duties 322 allows the step of a providing a machine learning classifier 323 which leads to the step of building a harmonized system with AI 324. The substeps generate a classification model 325. Thus, the centralized distributed agentic AI system includes an AI question answer model 310 having access to documentation 348 and classification 325 which allows the centralized distributed agentic AI system 300 to apply the AI question answer model 310 to the documentation 348.

The centralized distributed agentic AI system 300 can also have a data evaluation and prediction step 332 which receives market trend analysis and risk projections 333 which includes the steps of providing a convolutional neural network CNN 335, a recurrent neural network 336 and a long-term memory LSTM 337. The select the right business decision 334 model can work with the market trend analysis and risk prediction model 333 to provide an improved overall data evaluation and prediction 332.

The centralized distributed agentic AI system 300 can also have a data security and privacy step 338 that can include a protection of user data encryption protocol 339, and a data transparency and security protocol 342 that is encrypted on block chain 343. The user data encryption protocol 339 may include a homomorphic encryption 340 with differential privacy 341. A filtering step 344 can include filter suppliers with AI 345, filter customers with AI 346, and filter intermediaries with AI 347.

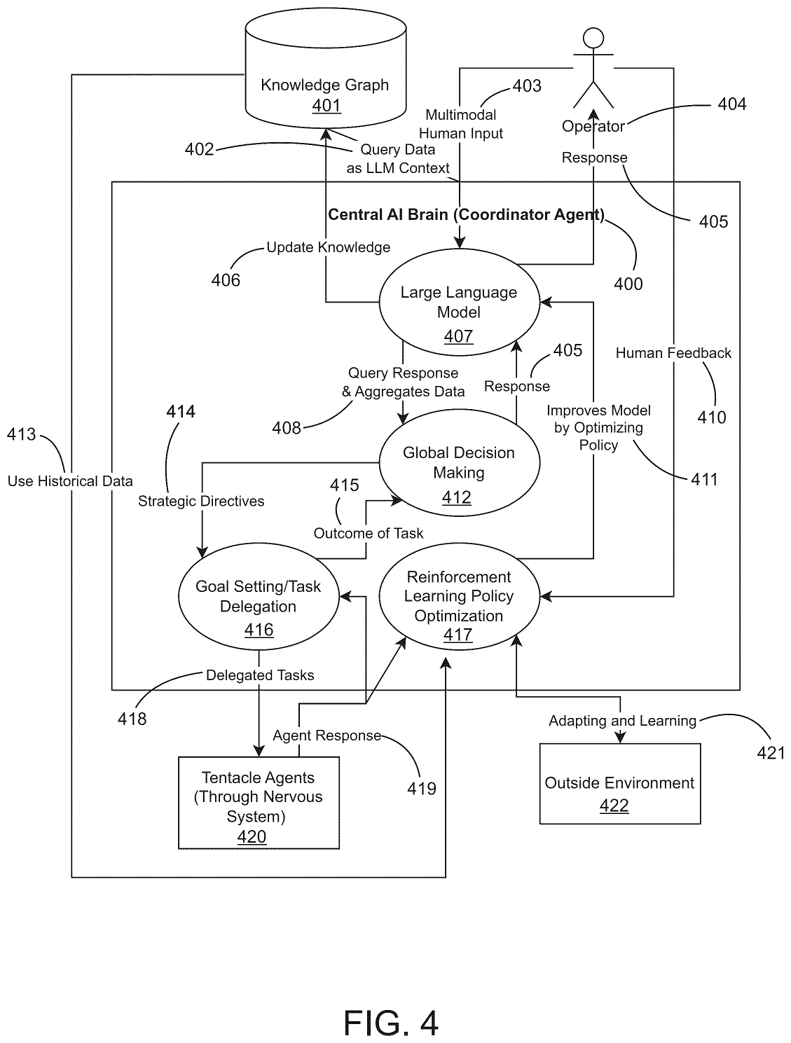

As seen in FIG. 4, an operator 404 can create a multimodal human input 403 to a large language model 407. The large language model allows communication and input verbally, by text or otherwise. The operator 404 can also provide human feedback 410 to a reinforcement learning policy optimization algorithm 417. The reinforcement learning policy optimizer 417 can then implement the step of improving the model by optimizing policy 411 on the large language model 407.

The coordinator agent 400 is a central brain that coordinates between different agents preferably in natural language which can be by text or audio. The coordinator agent 400 can query data as LLM context 402 from the knowledge graph 401. This allows the coordinator agent 400 to operate with a persistent and up-to-date data. The operator 404 can receive a response 405.

The large language model 407 updates knowledge 406 to the knowledge graph 401. The knowledge graph 401 can use historical data 413. Such historical data is available to the reinforcement learning policy optimization algorithm 417. The reinforcement learning policy optimization 417 also receives an adaptation and learning 421 from an outside environment 422. The large language model 407 works with the global decision making model 412 to implement the strategic directives 414. The strategic directives 414 are sent to a goal setting and task delegation model 416. The task outcome 415 is then input from the goal setting task delegation model 416 back to the global decision making model 412. The global decision making model 412 therefore is an intermediary between the large language model, the goal setting task delegation model 416 and the reinforcement learning policy optimization model 417. The global decision making model 412 receives a task outcome from the goal setting task delegation model 416, and receives a query response and aggregate data 408 from the large language model 407. The global decision making model 412 provides a response 405 to the large language model 407. The global decision making model sends strategic directives 414 to the goal setting task delegation model 416.

The tentacle agents 420 are connected through the nervous system and produce an agent response 419 back to the goal setting and task delegation model 416 of the coordinator agent 400. The tentacle agents receive delegated tasks 418 and respond through the nervous system. The agent response 419 also travels from the tentacle agents 420 to the reinforcement learning policy optimization model 417. The reinforcement learning policy optimization model 417 thus receives agent responses 419, historical data 413, human feedback 410 and direct sensor input in the form of adapting and learning data 421 from the outside environment 422.

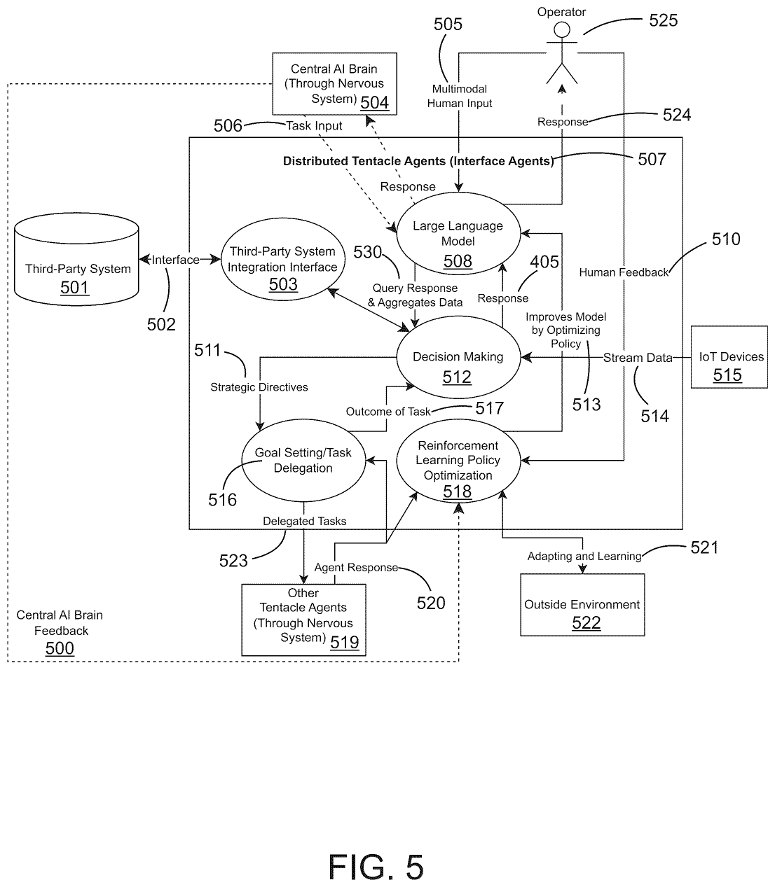

As seen in FIG. 5, the interface agents 507 are distributed tentacle agents and also can receive a multimodal human input 505 and sent a response 524 to an operator 525. The operator 525 is a human user. The multimodal human input 505 can be text, audio or the like. The operator can also send human feedback 5102 the reinforcement learning policy optimization module 518.

Like the coordinator agent 400, the interface agents 507 have a large language model 508, a decision-making model 512, a goal setting task delegation model 516, and a reinforcement learning policy optimization model 518. The large language model sends a response to the central brain 504 through the nervous system and receives task input 506 from the central AI brain 504. Thus, the large language model is connected to both the central AI brain and the human operator 525. The decision-making model receives query response and aggregate data 530 from the large language model 508, receives task outcomes 517 from the goal setting task delegation model 516, and receives stream data 514 from IoT devices 515.

The interface agent's large language model 508 gives an interface agent response 524 to the operator 525. The operator 535 can also give human feedback 510 to the reinforcement learning policy optimization model 518. The reinforcement learning policy optimization model 518 receives an agent response 520 from other tentacle agents 519, and receives central brain feedback 500, and receives adaptation and learning data from an outside environment 522. The large language model 508 sends query response and aggregate data 530 and receives responses 405 from the decision-making model. The decision making model 512 sends strategic directives 511 to the goal setting task delegation model 516, and receives task outcome data 517 from the goal setting task delegation model 516.

The coordinator agent 400 also has a reinforcement learning policy optimization model 518 which receives agent responses 520, central AI brain feedback 500, and adapting and learning data 521.

The coordinator agent has a third-party system integration interface 503 connected to the decision-making model 512. The decision-making model 512 controls the third-party system integration interface 503 and the interface data 502 connects to the third-party system 501. The third-party system 501 is thus handled by the interface agent 507, and the interface agent 507 is managed by a coordinator agent 400. In this way, a user has a choice to interact with the coordinator agent 400 or the interface agent 507 to effectuate a result with the third-party system 501.

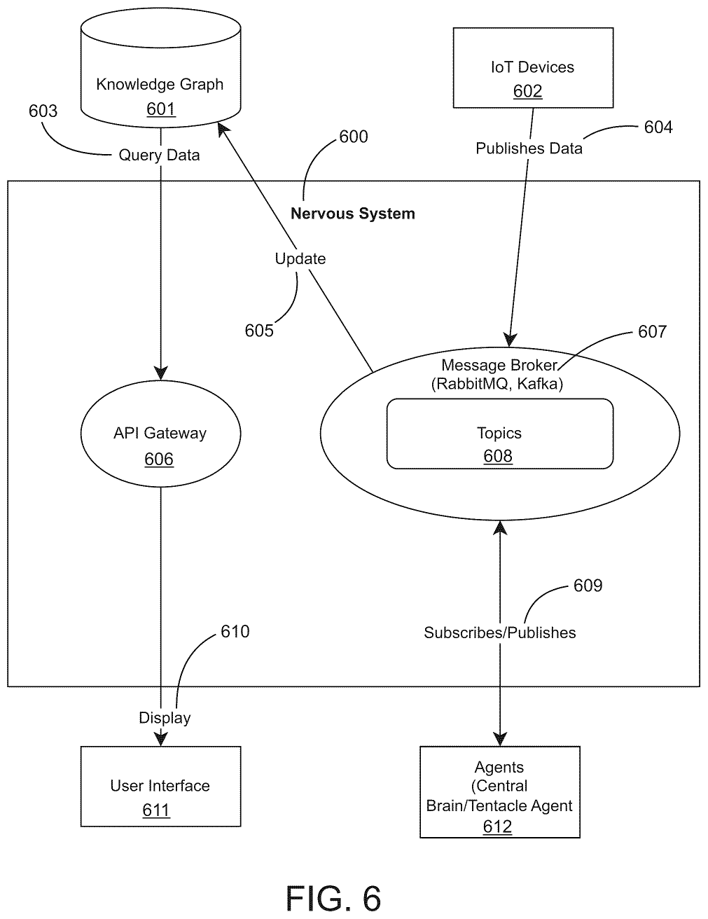

As seen in FIG. 6, the nervous system 600 includes a message broker 601 and an API Gateway 606. The API Gateway 606 receives API requests from clients and routes these requests to the appropriate backend services, then aggregates responses from multiple backend services into a single response for the client. The API Gateway 606 handles query data 603 from a knowledge graph 601. The knowledge graph 601 is a graphical data model that defines interrelationships between real-world objects, people, places, and events to enable machine learning and machine reference of complex relationships. A user interface 611 may have a display 610 that a user can reference, or another AI can reference.

The message broker 607 can be implemented on an open source platform such as RabbitMQ and Kafka. RabbitMQ can enable flexible routing, ease of use, and support for multiple protocols like AMQP, MQTT, and STOMP while Kafka provides for a high throughput for real-time data streaming, which is advantageous for event sourcing, data aggregation, and log aggregation. The message broker 607 can facilitate topics 608. Topics 608 supported on the message broker can broadcast messages. The message broker 607 sends updates 605 to the knowledge graph 601. The message broker 607 receives published data 604 from Internet of things devices 602. The agents 612 include the central brain and tentacle agents which subscribe and publish 609 to the topics 608 on the message broker.

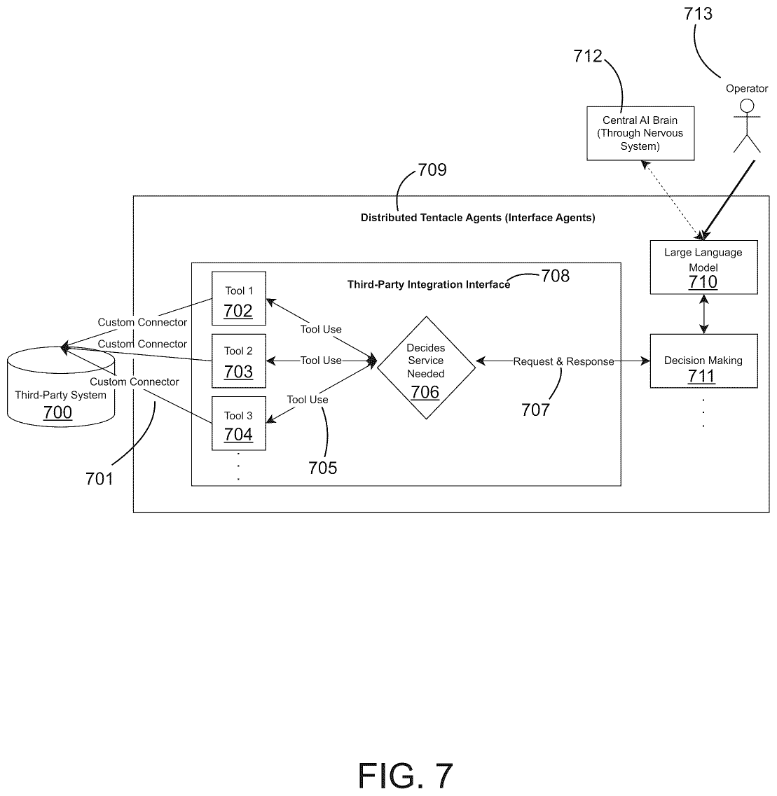

As seen in FIG. 7, the general system diagram shows the operator 713 and the central AI brain 712 interacting with the large language model 710 which interacts with the decision-making model 711. The decision-making model 711 sends requests and responses 707 in a third-party integration interface 708. The request and responses 707 connect to the decide services needed 706 which controls multiple tools such as tool one 702, tool two 703, tool three 704. Tool use 705 commands to the tools to activate the tools and the tools interact with the third party system 700 through custom connectors 701.

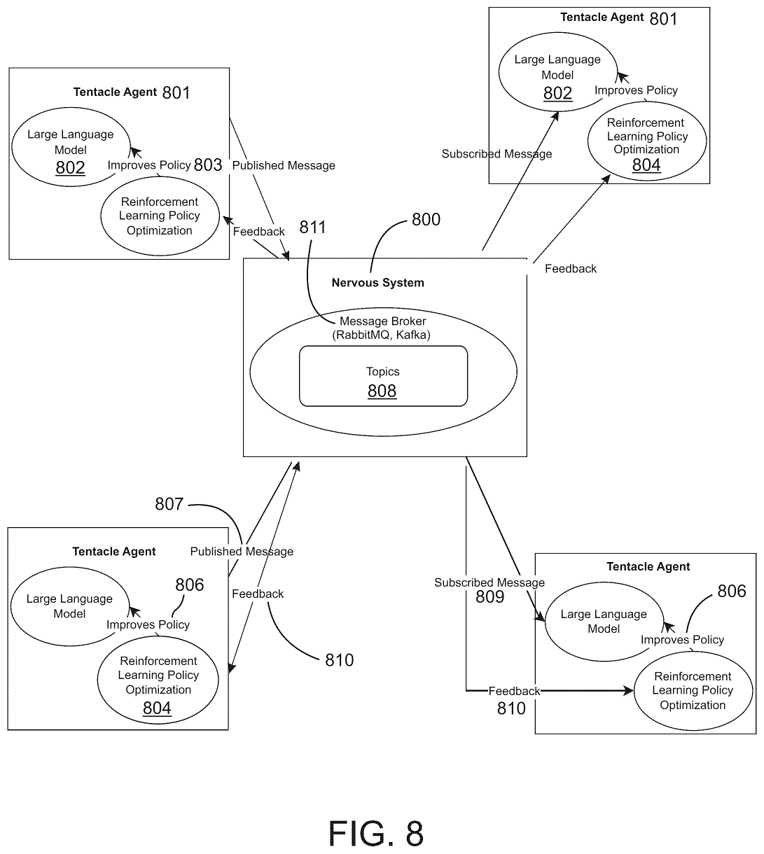

As seen in FIG. 8, the nervous system 800 has a message broker 811 hosting topics 808. The topics 808 allow communication such as subscribed messages 809, published messages 807, and thus generally feedback 810 between the tentacle agents 801. A tentacle agent 801 can have a large language model 802 which receives a subscribe message. The reinforcement learning policy optimization model 804 can improve policy 803, 806 to the large language model 802.

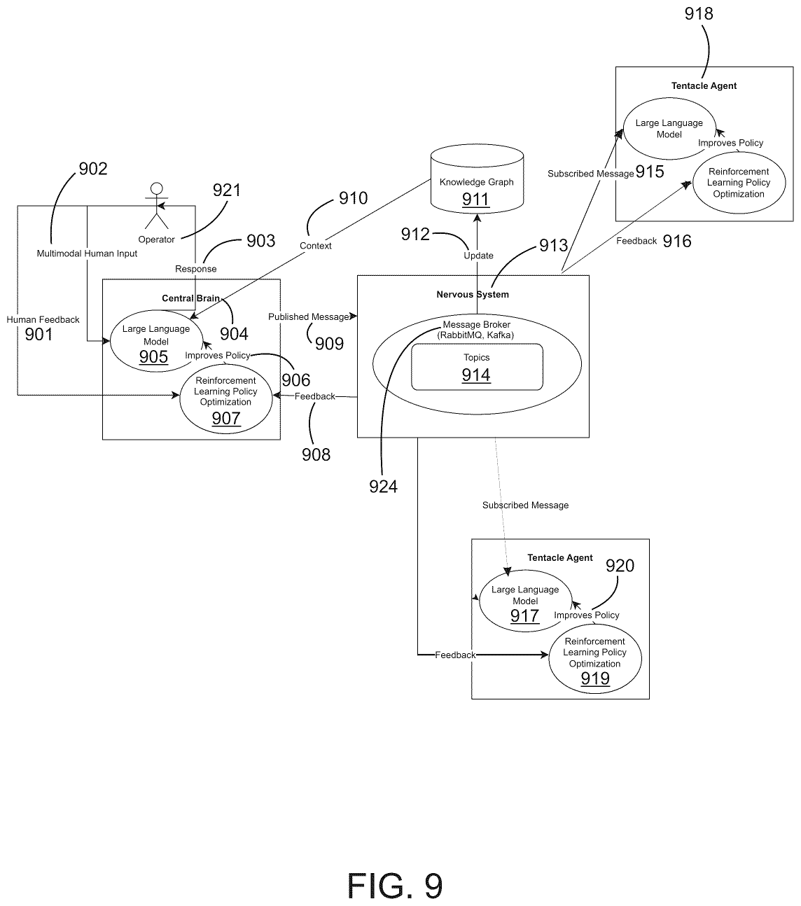

As seen in FIG. 9, the nervous system 913 provides an update 912 to a knowledge graph 911. Again, the nervous system has a message broker 924 hosting topics 914 which allow transmission and receiving of a subscribed messages 915, feedback 916, 908 and receive published messages 909. The reinforcement learning policy optimization model 919 sends improve policy data 906, 920 two the large language model 905, 917 in various different agents such as the tentacle agent 918 or the central brain 904. The operator 921 can provide a multimodal human input 902 to a large language model 905 of the central brain 904 or can provide a human feedback 901 to a reinforcement learning policy optimization model 907 of the central brain 904. The central brain 904 then sends published messages 909 and receives feedback 908 through the topics 914 posted on the message broker 924 of the nervous system 913. Context 910 can be data received from the knowledge graph 911 and received by the large language model 905 to allow the large language model 905 to interpret the multimodal human input 902.

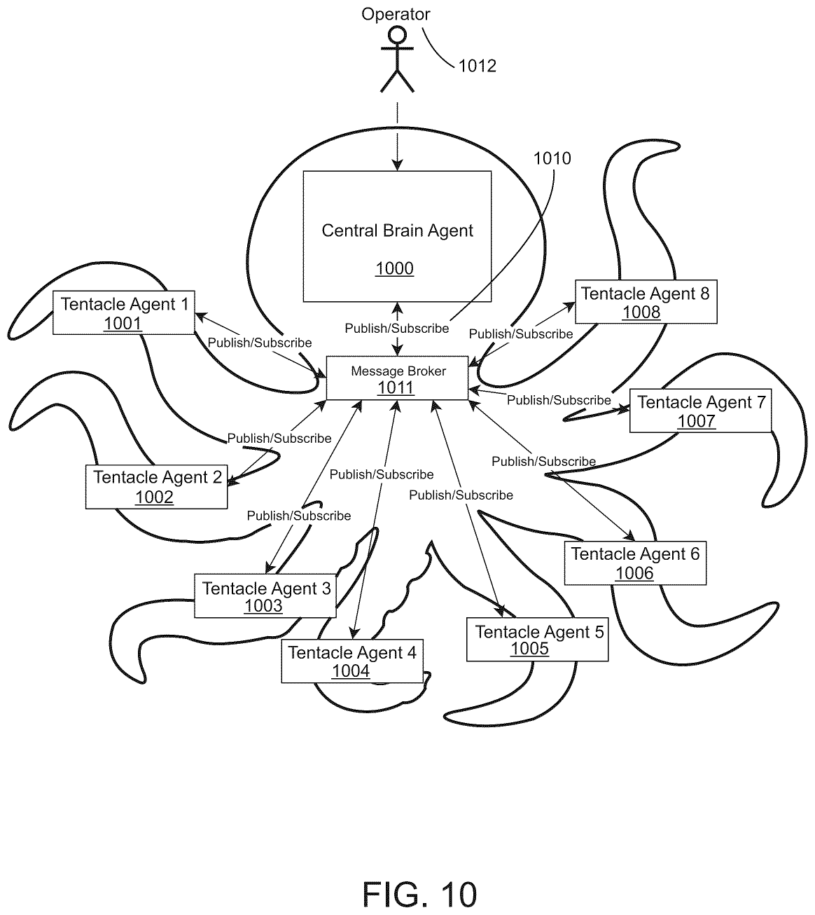

As seen in FIG. 10, the model of the centralized distributed agentic AI is analogous to an octopus's nervous system where the operator 1012 interacts with the central brain agent 1000 which then publishes and subscribes 1010 to a message broker 1011 which then communicates to a first tentacle agent 1001, a second tentacle agent 1002, a third tentacle agent 1003, a fourth tentacle agent 1004, a fifth tentacle agent 1005, a sixth tentacle agent 1006 a seventh tentacle agent 1007 and an eighth tentacle agent 1008.

As far as we know, the octopus nervous system has a hybrid centralized and distributed control. While an octopus has a central brain that handles complex decision-making, over 60% of its neurons are located in its arms, allowing each arm to sense, move, and even make decisions independently. This means the arms can explore and react to their environment without constant input from the brain, enabling fast, adaptive responses while still being coordinated as part of a larger system. The centralized distributed agentic artificial intelligence system is roughly modeled on the octopus nervous system.

The centralized distributed agentic artificial intelligence system can be used in a variety of different situations such as supply chain control Tower system, supply-chain manufacturing digital twin simulation system, and any system integration with a large organization where there are many legacy systems operating in silo before. A supply chain control tower is a centralized hub that provides end-to-end visibility and control over the supply chain. It integrates data from various sources to enhance decision-making and operational efficiency. The centralized distributed agentic artificial intelligence can enhance a supply chain control tower by performing real-time monitoring, predictive analytics, automated decision-making, and facilitating collaboration. The centralized distributed agentic artificial intelligence system can continuously monitor supply chain activities, providing real-time insights and alerts for any disruptions. The centralized distributed agentic artificial intelligence system can predict potential issues such as delays or demand fluctuations, allowing proactive measures. The centralized distributed agentic artificial intelligence system can autonomously make decisions to optimize inventory levels, reroute shipments, or adjust production schedules. The centralized distributed agentic artificial intelligence system can facilitate better collaboration among different stakeholders by providing a unified platform for communication and data sharing.

The centralized distributed agentic artificial intelligence system can also run a simulation. A digital twin is a virtual replica of physical assets, processes, or systems that allows for real-time monitoring and simulation. The centralized distributed agentic artificial intelligence system can enhance digital twin systems by simulating various scenarios to optimize manufacturing processes, identify bottlenecks, and improve efficiency. The centralized distributed agentic artificial intelligence system can predict equipment failures and schedule maintenance before issues arise, reducing downtime. The centralized distributed agentic artificial intelligence system can adapt the digital twin model in real-time based on new data, ensuring it accurately reflects the current state of the physical system. The centralized distributed agentic artificial intelligence system can provide actionable insights and recommendations based on the simulation results, helping managers make informed decisions. The centralized distributed agentic artificial intelligence system can perform system integration within a large organization with legacy systems.

System integration may include data integration. The centralized distributed agentic artificial intelligence system can bridge the gap between legacy systems and new applications, ensuring seamless data flow and interoperability. The centralized distributed agentic artificial intelligence system can perform process automation and automate repetitive tasks and workflows, reducing the reliance on outdated manual processes. The centralized distributed agentic artificial intelligence system can enhance security by monitoring for security vulnerabilities in legacy systems and implement measures to protect against breaches. The centralized distributed agentic artificial intelligence system can help scale the integration efforts by dynamically adjusting to the organization's evolving needs and technologies. Thus, these applications of the centralized distributed agentic artificial intelligence system can significantly enhance the efficiency, resilience, and adaptability of supply chain and manufacturing systems, as well as facilitate the integration of legacy systems within large organizations.

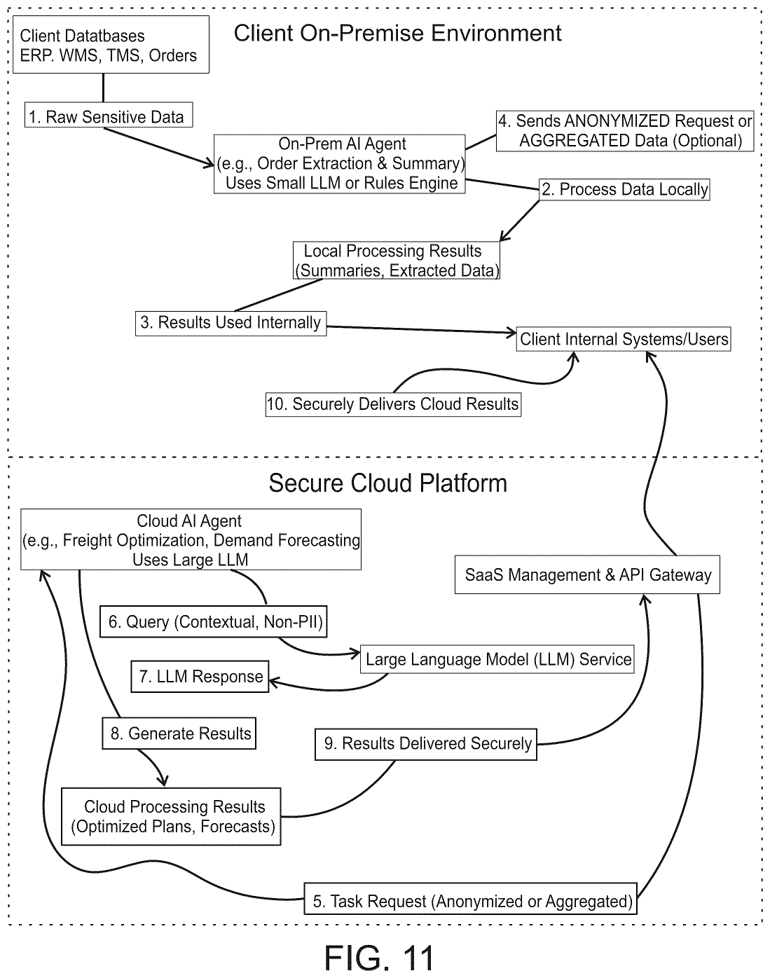

As seen in FIG. 11, a use case for this centralized distributed agentic architecture is the design and deployment of AI systems where computational workloads and decision-making are distributed across multiple nodes or services during real-time execution. This architecture allows scalability, fault tolerance, low latency, and responsiveness-especially in dynamic, data-rich environments like supply chains, smart cities, or autonomous systems. These systems adapt dynamically at runtime, leveraging federated learning and containerized services to operate efficiently across varied environments. Some AI agents operate at the edge (close to the source of data), while others work in the cloud to provide deeper analytics and learning. A prime use case is in supply chain management, where AI agents at factories and warehouses predict demand and optimize logistics locally, while cloud-based agents coordinate broader operations-allowing the system to respond instantly to disruptions like route blockages or demand fluctuations without centralized intervention.

1. A centralized distributed agentic artificial intelligence system comprising:
a. a central brain agent, wherein the central brain agent is configured to act as a coordinator agent, wherein the coordinator agent receives input from an operator, wherein the coordinator agent has a coordinator agent large language model that updates knowledge to a knowledge graph, wherein the coordinator agent receives historical data from the knowledge graph to a reinforcement learning policy optimization, wherein the reinforcement learning policy optimization sends model optimizing policy to the coordinator agent large language model;
b. a plurality of tentacle agents, wherein the plurality of tentacle agents are configured to act as interface agents, wherein the interface agents have a third-party system integration interface to a third-party system, wherein the plurality of tentacle agents each have an interface agent large language model, local decision making model, and a goal setting and task delegation model, wherein the interface agent large language model receives feedback from an interface agent reinforcement learning policy optimization, wherein the interface agent reinforcement learning policy optimization receives input from an agent response; and
c. a nervous system, wherein the nervous system includes a message broker, wherein the central brain agent publishes and subscribes to the message broker, wherein the plurality of tentacle agents publish and subscribe to the message broker, whereby the coordinator agent and interface agents communicate through the message broker.

2. The centralized distributed agentic artificial intelligence system of claim 1, wherein the central brain has a large language model and reinforcement learning policy optimization, wherein the reinforcement learning policy optimization improves the policy of the large language model.

3. The centralized distributed agentic artificial intelligence system of claim 1, wherein the plurality of tentacle agents have a large language model and reinforcement learning policy optimization, wherein the reinforcement learning policy optimization improves the policy of the large language model.

4. The centralized distributed agentic artificial intelligence system of claim 1, wherein the coordinator agent has a coordinator agent large language model which sends a query response and aggregate data, wherein the coordinator agent large language model receives responses from the decision-making model, wherein the decision making model sends strategic directives to the goal setting task delegation model, and receives task outcome data from the goal setting task delegation model.

5. The centralized distributed agentic artificial intelligence system of claim 1, wherein the interface agent's large language model gives an interface agent response to the operator, wherein the operator gives human feedback to the interface agent's reinforcement learning policy optimization model, wherein the interface agent's reinforcement learning policy optimization model also receives an agent response from other tentacle agents and receives central brain feedback.

6. The centralized distributed agentic artificial intelligence system of claim 5, wherein the message broker hosts one or more topics, wherein the interface agents and the coordinator agent are subscribed to and publish to the one or more topics.

7. The centralized distributed agentic artificial intelligence system of claim 5, wherein the plurality of tentacle agents have a large language model and reinforcement learning policy optimization, wherein the reinforcement learning policy optimization improves the policy of the large language model.

8. The centralized distributed agentic artificial intelligence system of claim 5, wherein the coordinator agent has a coordinator agent large language model which sends a query response and aggregate data, wherein the coordinator agent large language model receives responses from the decision-making model, wherein the decision making model sends strategic directives to the goal setting task delegation model, and receives task outcome data from the goal setting task delegation model.

9. The centralized distributed agentic artificial intelligence system of claim 5, wherein the interface agent's large language model gives an interface agent response to the operator, wherein the operator gives human feedback to the interface agent's reinforcement learning policy optimization model, wherein the interface agent's reinforcement learning policy optimization model also receives an agent response from other tentacle agents and receives central brain feedback.

10. The centralized distributed agentic artificial intelligence system of claim 9, wherein the message broker hosts one or more topics, wherein the interface agents and the coordinator agent are subscribed to and publish to the one or more topics.

11. The centralized distributed agentic artificial intelligence system of claim 9, wherein the plurality of tentacle agents have a large language model and reinforcement learning policy optimization, wherein the reinforcement learning policy optimization improves the policy of the large language model.

12. The centralized distributed agentic artificial intelligence system of claim 9, wherein the coordinator agent has a coordinator agent large language model which sends a query response and aggregate data, wherein the coordinator agent large language model receives responses from the decision-making model, wherein the decision making model sends strategic directives to the goal setting task delegation model, and receives task outcome data from the goal setting task delegation model.

13. The centralized distributed agentic artificial intelligence system of claim 12, wherein the message broker hosts one or more topics, wherein the interface agents and the coordinator agent are subscribed to and publish to the one or more topics, wherein the plurality of tentacle agents have a large language model and reinforcement learning policy optimization, wherein the reinforcement learning policy optimization improves the policy of the large language model.

14. The centralized distributed agentic artificial intelligence system of claim 13, wherein the centralized distributed agentic artificial intelligence system is configured for international trade, wherein the interface agents include: a sales agent; a workflow agent; and a marketplace agent.

15. The centralized distributed agentic artificial intelligence system of claim 1, wherein the centralized distributed agentic artificial intelligence system is configured for international trade, wherein the interface agents include: a sales agent; a workflow agent; and a marketplace agent.

16. The centralized distributed agentic artificial intelligence system of claim 15, wherein the centralized distributed agentic artificial intelligence system is configured as a supply chain control tower system, supply-chain manufacturing digital twin simulation system, or a system integrator of legacy systems previously operating in silo, wherein a centralized distributed agentic architecture has a central brain that is configured to distribute computational workloads and decision-making across multiple tentacle agents that act as nodes or services during real-time execution for improving scalability, fault tolerance, low latency, and responsiveness.

17. The centralized distributed agentic artificial intelligence system of claim 16, wherein the centralized distributed agentic artificial intelligence system is configured to adapt dynamically at runtime, and leverage federated learning and containerized services to operate efficiently across varied environments allowing some tentacle agents to operate at the edge, while others work in the cloud to provide deeper analytics and learning, whereby allowing the centralized distributed agentic artificial intelligence system to respond to disruptions like route blockages or demand fluctuations without centralized intervention by the central brain.

18. The centralized distributed agentic artificial intelligence system of claim 15, wherein the sales agent is configured to customer on boarding by gathering client information and import export requirements, wherein the sales agent is configured to create customer profiles with contact information and shipping preferences, wherein the sales agent is configured to perform the function of quoting and pricing, wherein the sales agent is configured to provide automated quoting based on shipment sizes and weight, wherein the sales agent is configured to calculate customs duties taxes and fees, wherein the workflow agent is configured to perform automatic data entry by extracting data from shipping documents and maintaining records including invoices, packing lists, and bills of lading, wherein the workflow agent is configured to use machine learning algorithms to classify products according to the harmonized system codes based on descriptions of classifications and tariffs, wherein the workflow agent is configured to prepare and submit documents by generating and compiling necessary customs documents automatically including entry summaries and declarations, wherein the marketplace agent is configured for vendor matching and recommendations including the step of utilizing machine learning algorithms to match buyers with suitable vendors based on preferences and historical transactions, wherein the marketplace agent is configured to perform a product search and discovery, including enhancing product search capabilities using natural language processing to understand user queries and return relevant results, wherein the marketplace agent is configured to optimize and negotiate prices by implementing dynamic pricing algorithms based on market demand and supply, wherein the marketplace agent is configured to support automated negotiation processes, and optimize supply chain management including inventory forecasting, demand prediction and logistics planning, wherein the marketplace agent is configured to perform transaction security and fraud prevention by implementing AI powered fraud detection systems to identify fraudulent transactions.
